(19) United States
(12) Patent Application Publication
(10) Pub. No.: US 2006/0262991 A1
(43) Pub. Date: Nov. 23, 2006

(54) Noise reduction method

(75) Inventors: Wei-Kuo Lee, Zhubei City (TW); Yun-Hung Shen, Hsinchu City (TW)

Correspondence Address: BRUCE H. TROXELL;SUITE 1404, 5205 LEESBURG PIKE, FALLS CHURCH, VA, 22041, US

(73) Assignee: Mstar Semiconductor Inc.

(21) Appl. No.: 11/432,551

(22) Filed: May 12, 2006

Related U.S. Application Data
(60) Provisional application No. 60/682,407, filed on May 19, 2005.

(51) Int. Cl. G06K 9/40

(52) U.S. Cl. 382/274

(57) ABSTRACT

The present invention provides a noise reduction method for use in reducing noise of a digital image, the method comprising steps of: providing at least a luminance threshold value; determining at least a luminance feature value according to the luminance value of a target pixel and the luminance values of neighboring pixels of the target pixel; determining whether the target pixel is a noise point based on the comparison between each luminance feature value and each luminance threshold value corresponding thereto; and adjusting the luminance value, a first chrominance value and a second chrominance value of the target pixel if the target pixel is determined a noise point. Using the noise reduction method of the present invention, not only noise of a digital image can be identified, but also the degradation caused by the noise can be reduced and thus the overall picture quality can be improved.

### 1. FIELD OF THE INVENTION

The present invention generally relates to a noise reduction method and, more particularly, to a noise reduction method using a luminance value of a target pixel and luminance values of neighboring pixels of the target pixel so as to identify and eliminate a noise point of a digital image.

### 2. DESCRIPTION OF THE PRIOR ART

In digital image processing, the most generally used method to reduce noise is to directly process the pixels related to the image. For example, averaging filters and sequence statistical filters are used according to respective requirements.

Conventionally, impulse noise is eliminated using a median filter, which is a non-linear spatial filter operating corresponding to the pixel values in a neighboring region of a target pixel so as to sort the pixel values and then make the median pixel replace the target pixel. However, the median filter performs pixel adjustment for the entire image including some non-noise portions. Therefore, the noise reduction process using the median filter may lead to undesirable distortion of the image because it cannot identify where noise occurs. Moreover, since the pixel is adjusted according to the pixel values of the neighboring pixels, the adjusted image shows unnaturalness in luminance and chrominance.

Accordingly, the present invention provides a noise reduction method not only to identify noise of a digital image, but also to reduce noise by adjusting the luminance value and the chrominance value to avoid image distortion.

Compared to the prior art, the noise reduction method of the present invention exhibits excellent performance in noise reduction while remaining the original colors in the region where there is no noise determined.

It is a primary object of the present invention to provide a noise reduction method so as to identify noise in a digital image and adjust the luminance value and the chrominance values of a pixel that is determined a noise point so that the image quality is improved and the image distortion is avoided.

In order to achieve the foregoing object, the present invention provides a noise reduction method, comprising steps of: providing at least a luminance threshold value; determining at least a luminance feature value according to a luminance value of a target pixel and luminance values of neighboring pixels of the target pixel; determining whether the target pixel is a noise point based on the comparison between each luminance feature value and each luminance threshold value corresponding thereto; and adjusting the luminance value of the target pixel if the target pixel is determined a noise point.

The luminance feature value is determined by: (1) the luminance value of the target pixel and the luminance values of four neighboring pixels, the target pixel and the four neighboring pixels forming a cross shape; (2) the luminance value of the target pixel and the luminance values of four neighboring pixels, the target pixel and the four neighboring pixels forming an X shape; (3) the luminance values of the neighboring pixels; or (4) the luminance value of the target pixel and a mean luminance value of the neighboring pixels.

Preferably, the luminance feature value comprises a first luminance feature value, a second luminance feature value, a third luminance feature value and a fourth luminance feature value. The first luminance feature value is determined by the luminance value of the target pixel and the luminance values of four neighboring pixels, the target pixel and the four neighboring pixels forming a cross shape. The second luminance feature value is determined by the luminance value of the target pixel and the luminance values of four neighboring pixels, the target pixel and the four neighboring pixels forming an X shape. The third luminance feature value is determined by the luminance values of the neighboring pixels. The fourth luminance feature value is determined by the luminance value of the target pixel and a mean luminance value of the neighboring pixels.

Preferably, the luminance threshold value comprises: a first luminance threshold value, a second luminance threshold value, a third luminance threshold value and a fourth luminance threshold value. The first luminance threshold value, the second luminance threshold value and the third luminance threshold value are pre-determined. The fourth luminance threshold value is determined by the luminance values of the neighboring pixels of the target pixel and the mean luminance value of the neighboring pixels of the target pixel.

Preferably, the first luminance feature value is larger than the first luminance threshold value, the second luminance feature value is larger than the second luminance threshold value, the third luminance feature value is smaller than the third luminance threshold value and the fourth luminance feature value is larger than the fourth luminance threshold value, so that the target pixel is determined a noise point.

The step of adjusting the luminance value of the target pixel comprises steps of: selecting a luminance median from a series including the luminance value of the target pixel and the luminance values of the neighboring pixels; and performing a luminance weighting calculation so as to adjust the luminance value of the target pixel according to the luminance median.

The step of adjusting the chrominance value of the target pixel comprises steps of: selecting a chrominance median from a series including the chrominance value of the target pixel and chrominance values of the neighboring pixels; and performing a chrominance weighting calculation so as to adjust the chrominance value of the target pixel according to the chrominance median.

Accordingly, the present invention provides a noise reduction method using the luminance profile of the target pixel and its neighboring pixels to determine a plurality of luminance feature values to be compared with a plurality of luminance threshold values so as to determine whether the target pixel is infected with noise, which is to be eliminated by adjusting the luminance value and the chrominance value of the target pixel.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a flowchart showing steps of the noise reduction method according to the preferred embodiment of the present invention;

FIG. 2 is a schematic diagram showing a target pixel and its neighboring pixels according to the preferred embodiment of the present invention; and

FIG. 3 is a detailed flowchart showing steps of the noise reduction method according to the preferred embodiment of the present invention.

### DETAILED DESCRIPTION OF THE PREFERRED

The present invention providing a noise reduction method can be exemplified by the preferred embodiment as described hereinafter.

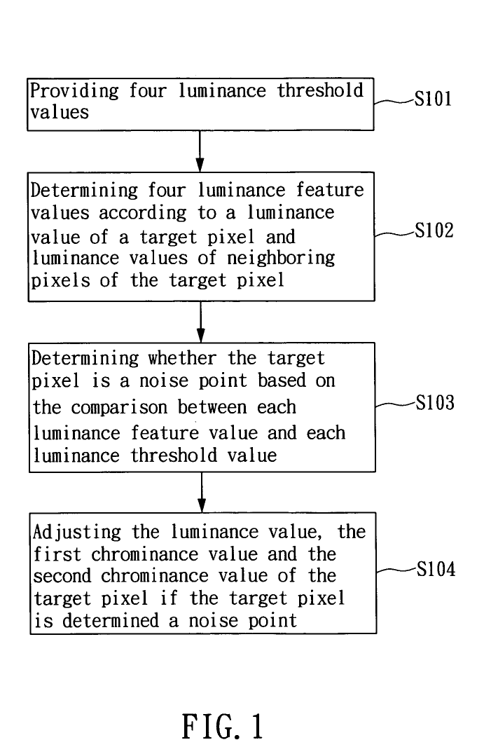

Please refer to FIG. 1, which is a flowchart showing steps of the noise reduction method according to the preferred embodiment of the present invention. First, as described in Step S101, four luminance threshold values are provided. The first luminance threshold value, the second luminance threshold value and the third luminance threshold value are pre-determined. The fourth luminance threshold value is determined by the luminance values of the neighboring pixels of a target pixel and the mean luminance value of the neighboring pixels of the target pixel.

Then, in Step S102, four luminance feature values are determined according to a luminance value of the target pixel and the luminance values of neighboring pixels of the target pixel. The first luminance feature value is determined by the luminance value of the target pixel and the luminance values of four neighboring pixels, the target pixel and the four neighboring pixels forming a cross shape. The second luminance feature value is determined by the luminance value of the target pixel and the luminance values of four neighboring pixels, the target pixel and the four neighboring pixels forming an X shape. The third luminance feature value is determined by the luminance values of the neighboring pixels. The fourth luminance feature value is determined by the luminance value of the target pixel and a mean luminance value of the neighboring pixels.

In Step S103, each luminance feature value and each luminance threshold value are compared so as to determine whether the target pixel is a noise point. The first luminance feature value is larger than the first luminance threshold value, the second luminance feature value is larger than the second luminance threshold value, the third luminance feature value is smaller than the third luminance threshold value and the fourth luminance feature value is larger than the fourth luminance threshold value, so that the target pixel is determined a noise point.

Finally, in Step 104, the luminance value and the chrominance value of the target pixel is adjusted if the target pixel is determined a noise point. The step of adjusting the luminance value of the target pixel comprises steps of: selecting a luminance median from a series including the luminance value of the target pixel and the luminance values of the neighboring pixels; and performing a luminance weighting calculation so as to adjust the luminance value of the target pixel according to the luminance median. The step of adjusting the chrominance value of the target pixel comprises steps of: selecting a chrominance median from a series including the chrominance value of the target pixel and chrominance values of the neighboring pixels; and performing a chrominance weighting calculation so as to adjust the chrominance value of the target pixel according to the chrominance median.

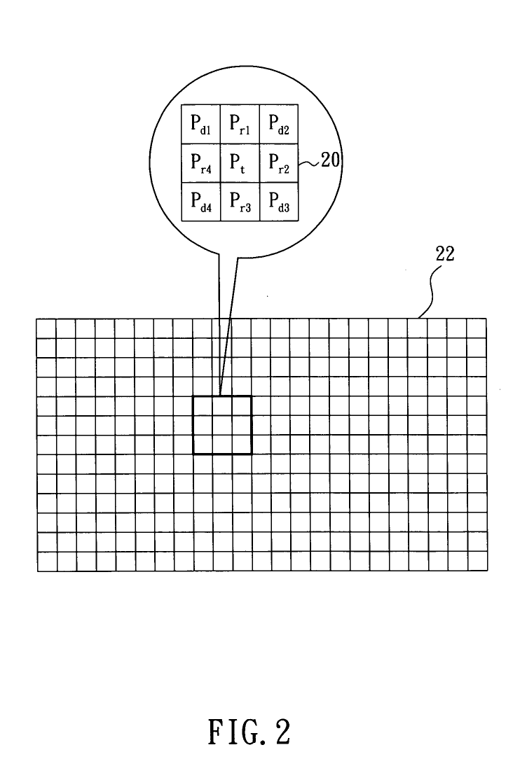

Please refer to FIG. 2, which is a schematic diagram showing a target pixel and its neighboring pixels according to the preferred embodiment of the present invention. A 3×3 mask 20 comprises nine pixels, wherein the central pixel Pt is a target pixel and the neighboring pixels that forms a X shape with the target pixel are Pd1, Pd2, Pd3, Pd4 and the neighboring pixels that forms a cross shape with the target pixel are Pr1, Pr2, Pr3, Pr4. When the target pixel Pt moves from one point in a digital image 22 to another, the mask 20 also moves.

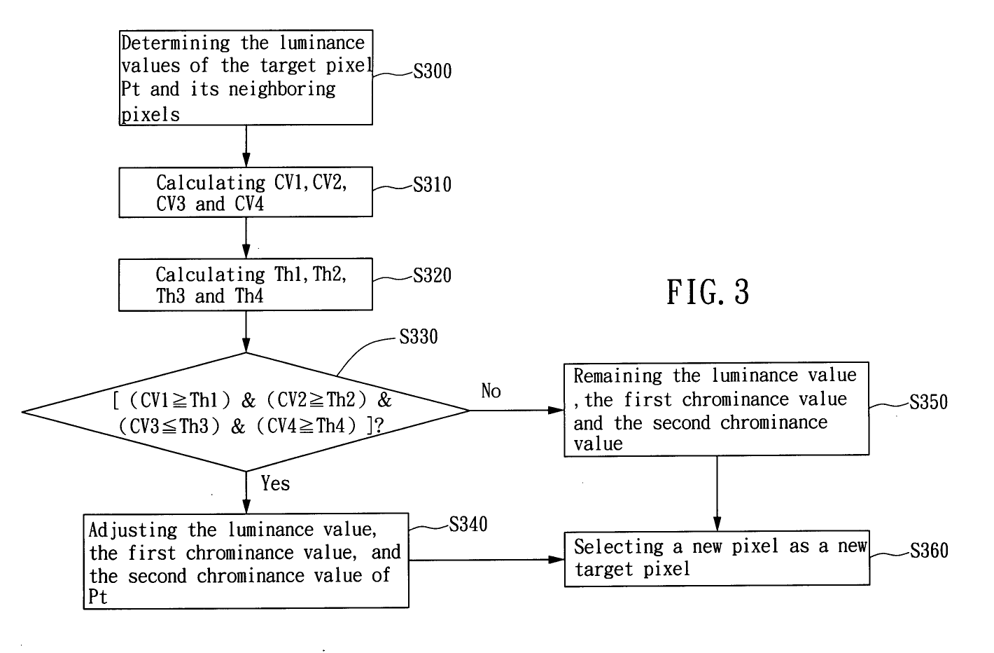

Please refer to FIG. 3, which is a detailed flowchart showing steps of the noise reduction method according to the preferred embodiment of the present invention. First, in Step S300, the luminance value of the target pixel and the luminance values of the neighboring pixels are determined so as to obtain a 3×3 matrix of luminance values, wherein Yt is the luminance value of the target pixel Pt; Yr2, Yr2, Yr3, Yr4 are luminance values corresponding to Pr1, Pr2, Pr3, Pr4, respectively; and Yd1, Yd2, Yd3, Yd4 are luminance values corresponding to Pd1, Pd2, Pd3, Pd4, respectively.

Then, in Step 310, the first luminance feature value CV1, the second luminance feature value CV2, the third luminance feature value CV3, and the fourth luminance feature value CV4 are calculated. CV1, CV2, CV3, and CV4 are expressed as:
CV1=abs[Yr1+Yr2+Yr3+Yr4−K1×Yt]
CV2=abs[Yd1+Yd2+Yd3+Yd4−K2×Yt]
CV3=abs[(Yd1+Yd2+Yd3+Yd4)−(Yr1+Yr2+Yr3+Yr4)]
CV4=abs[Yt−Y_mean]×K4

where K1, K2, K3, K4 are constants, Y_mean is a mean value of Yr1, Yr2, Yr3, Yr4, Yd1, Yd2, Yd3, Yd4 and abs is an absolute value operator.

Later in Step 320, the first luminance threshold value Th1, the second luminance threshold value Th2, the third luminance threshold value Th3, and the fourth luminance threshold value Th4 are calculated. Th1, Th2, Th3, and Th4 are luminance threshold values corresponding to CV1, CV2, CV3, and CV4, respectively. The first luminance threshold value Th1, the second luminance threshold value Th2 and the third luminance threshold value Th3 are pre-determined. The fourth luminance threshold value Th4 is expressed as:

$$Th 4 = abs [ Yr 1 - Y\_mean ] + abs [ Yr 2 - Y\_mean ] + abs [ Yr 3 - Y\_mean ] + abs [ Yr 4 - Y\_mean ] + abs [ Yd 1 - Y\_mean ] + abs [ Yd 2 - Y\_mean ] + abs [ Yd 3 - Y\_mean ] + abs [ Yr 4 - Y\_mean ]$$

The Step S310 and the Step S320 are in no particular order. In other words, the luminance threshold values can be calculated prior to the calculation of the luminance feature values. After the luminance threshold values and the luminance feature values are obtained, in Step S330, a comparison is made between each luminance threshold value and each luminance feature value so as to determine whether CV1, CV2, CV3 and CV4 are larger than, smaller than or equal to the corresponding Th1, Th2, Th3, and Th4, respectively. The comparison is to determine whether the following statement is true:
[(CV1≧Th1)&(CV2≧Th2)&(CV3≦Th3)&(CV4≧Th4)]

The target pixel Pt is determined a noise point if the statement is true; otherwise, the target pixel Pt is determined a non-noise point.

Finally, in Step 340, the luminance value, a first chrominance value and a second chrominance value of the target pixel Pt are adjusted if the target pixel Pt is determined a noise point. The adjusted luminance value, first chrominance value and second chrominance value are expressed as:
Yt_new=(1−W1)×Yt+W1×Y_median
Cbt_new=(1−W2)×Cbt+W2×Cb_median
Crt_new=(1−W3)×Crt+W3×Cr_median

where Yt_new, Cbt_new, Crt_new are the adjusted luminance value, first chrominance value and second chrominance value of the target pixel Pt, respectively; Ybt, Cbt and Crt are the original luminance value, first chrominance value and second chrominance value of the target pixel Pt, respectively; W1, W2 and W3 are weighting values; and Y_median, Cb_median and Cr_median are respectively a luminance median, a first chrominance median and a second chrominance median of a series [Pt, Pd1, Pd2, Pd3, Pd4, Pr1, Pr2, Pr3, Pr4].

In Step S350, the luminance value, first chrominance value and second chrominance value of the target pixel Pt are remained if the target pixel Pt is determined a non-noise point.

After Step 340 or Step 350, another pixel is selected as a new target pixel, as described in Step 360.

Accordingly, through the afore-mentioned steps, the noise point in the digital image 22 can not only be identified, but also be eliminated by adjusting the luminance value and the chrominance values.

According to the above discussion, it is apparent that the present invention discloses a noise reduction method so as to identify noise in a digital image and adjust the luminance value and the chrominance values of a pixel that is determined a noise point so that the image quality is improved and the image distortion is avoided.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A noise reduction method for use in reducing noise of a digital image, the method comprising steps of:
providing at least a luminance threshold value;
determining at least a luminance feature value according to a luminance value of a target pixel and luminance values of neighboring pixels of the target pixel;
determining whether the target pixel is a noise point based on the comparison between each luminance feature value and each luminance threshold value corresponding thereto; and
adjusting the luminance value of the target pixel if the target pixel is determined a noise point.

2. The noise reduction method as recited in claim 1, wherein the luminance feature value is determined by the luminance value of the target pixel and the luminance values of four neighboring pixels, the target pixel and the four neighboring pixels forming a cross shape.

3. The noise reduction method as recited in claim 1, wherein the luminance feature value is determined by the luminance value of the target pixel and the luminance values of four neighboring pixels, the target pixel and the four neighboring pixels forming an X shape.

4. The noise reduction method as recited in claim 1, wherein the luminance feature value is determined by the luminance values of the neighboring pixels.

5. The noise reduction method as recited in claim 1, wherein the luminance feature value is determined by the luminance value of the target pixel and a mean luminance value of the neighboring pixels.

6. The noise reduction method as recited in claim 1, wherein the luminance feature value comprises:
a first luminance feature value determined by the luminance value of the target pixel and the luminance values of four neighboring pixels, the target pixel and the four neighboring pixels forming a cross shape;
a second luminance feature value determined by the luminance value of the target pixel and the luminance values of four neighboring pixels, the target pixel and the four neighboring pixels forming an X shape;
a third luminance feature value determined by the luminance values of the neighboring pixels; and
a fourth luminance feature value determined by the luminance value of the target pixel and a mean luminance value of the neighboring pixels.

7. The noise reduction method as recited in claim 6, wherein the luminance threshold value comprises: a first luminance threshold value, a second luminance threshold value, a third luminance threshold value and a fourth luminance threshold value.

8. The noise reduction method as recited in claim 7, wherein the first luminance feature value is larger than the first luminance threshold value, the second luminance feature value is larger than the second luminance threshold value, the third luminance feature value is smaller than the third luminance threshold value and the fourth luminance feature value is larger than the fourth luminance threshold value, so that the target pixel is determined a noise point.

9. The noise reduction method as recited in claim 8, wherein the fourth luminance threshold value is determined by the luminance values of the neighboring pixels of the target pixel and the mean luminance value of the neighboring pixels of the target pixel.

10. The noise reduction method as recited in claim 1, further comprising a step of:
adjusting a chrominance value of the target pixel if the target pixel is determined a noise point.

11. The noise reduction method as recited in claim 1, wherein the step of adjusting the luminance value of the target pixel comprises steps of:
selecting a luminance median from a series including the luminance value of the target pixel and the luminance values of the neighboring pixels; and
performing a luminance weighting calculation so as to adjust the luminance value of the target pixel according to the luminance median.

12. The noise reduction method as recited in claim 10, wherein the step of adjusting the chrominance value of the target pixel comprises steps of:
selecting a chrominance median from a series including the chrominance value of the target pixel and chrominance values of the neighboring pixels; and
performing a chrominance weighting calculation so as to adjust the chrominance value of the target pixel according to the chrominance median.

13. The noise reduction method as recited in claim 11, wherein the luminance weighting calculation is expressed as:
Yt_new=(1−W1)×Yt+W1×Y_median
wherein Yt_new is an adjusted luminance value of the target pixel, W1 is a first weighting value, Yt is the luminance value of the target pixel and Y_median is the luminance median.

14. The noise reduction method as recited in claim 12, wherein the chrominance weighting calculation is expressed as:
Ct_new=(1−W2)×Ct+W2×C_median
wherein Ct_new is an adjusted chrominance value of the target pixel, W2 is a second weighting value, Ct is the chrominance value of the target pixel and C_median is the chrominance median.

15. The noise reduction method as recited in claim 2, wherein the luminance feature value is expressed as:
CV1=abs[Yr1+Yr2+Yr3+Yr4−K1×Yt]
wherein CV1 is the luminance feature value, Yt is the luminance value of the target pixel, Yr1, Yr2, Yr3, Yr4 are respectively the luminance values of four neighboring pixels that form the cross shape with the target pixel, K1 is a constant and abs is an absolute value operator.

16. The noise reduction method as recited in claim 3, wherein the luminance feature value is expressed as:
CV2=abs[Yd1+Yd2+Yd3+Yd4−K2×Yt]
wherein CV2 is the luminance feature value, Yt is the luminance value of the target pixel, Yd1, Yd2, Yd3, Yd4 are respectively the luminance values of four neighboring pixels that form the X shape with the target pixel, K2 is a constant and abs is an absolute value operator.

17. The noise reduction method as recited in claim 4, wherein the luminance feature value is expressed as:
CV3=abs[(Yd1+Yd2+Yd3+Yd4)−(Yr1+Yr2+Yr3+Yr4)]
wherein CV3 is the luminance feature value, Yd1, Yd2, Yd3, Yd4 are respectively the luminance values of four neighboring pixels that form the X shape with the target pixel, Yr1, Yr2, Yr3, Yr4 are respectively the luminance values of four neighboring pixels that form the cross shape with the target pixel, and abs is an absolute value operator.

18. The noise reduction method as recited in claim 5, wherein the luminance feature value is expressed as:
CV4=abs[Yt−Y_mean]×K4
wherein CV4 is the luminance feature value, Yt is the luminance value of the target pixel, Y_mean is the mean luminance value of the neighboring pixels of the target pixel, K4 is a constant and abs is an absolute value operator.

19. The noise reduction method as recited in claim 9, wherein the fourth luminance threshold value is expressed as:
$$Th 4 = abs [ Yr 1 - Y\_mean ] + abs [ Yr 2 - Y\_mean ] + abs [ Yr 3 - Y\_mean ] + abs [ Yr 4 - Y\_mean ] + abs [ Yd 1 - Y\_mean ] + abs [ Yd 2 - Y\_mean ] + abs [ Yd 3 - Y\_mean ] + abs [ Yr 4 - Y\_mean ]$$
wherein Th4 is the fourth luminance threshold value, Yd1, Yd2, Yd3, Yd4 are respectively the luminance values of four neighboring pixels that form the X shape with the target pixel, Yr1, Yr2, Yr3, Yr4 are respectively the luminance values of four neighboring pixels that form the cross shape with the target pixel, Y_mean is the mean luminance value of the neighboring pixels of the target pixel and abs is an absolute value operator.

20. The noise reduction method as recited in claim 1, wherein the luminance value of the target pixel is remained unchanged if the target pixel is determined a non-noise point.
